(19) United States
(12) Patent Application Publication
(10) Pub. No.: US 2018/0340753 A1
(43) Pub. Date: Nov. 29, 2018

(54) ILLUMINATED OPTICAL SIGHT RETICLE ASSEMBLY

(71) Applicant: Leupold & Stevens, Inc., Beaverton, OR (US)

(72) Inventor: Timothy Edmund Griffin, Portland, OR (US)

(73) Assignee: Leupold & Stevens, Inc., Beaverton, OR (US)

(21) Appl. No.: 15/988,271

(22) Filed: May 24, 2018

Related U.S. Application Data
(60) Provisional application No. 62/511,652, filed on May 26, 2017.
(60) Provisional application No. 62/512,252, filed on May 30, 2017.

(51) Int. Cl. F41G 1/34; G02B 23/14; G02B 27/34; G02B 23/12; F41G 1/38

(52) U.S. Cl. CPC F41G 1/345; G02B 23/14; F41G 1/38; G02B 23/12; G02B 27/34

(57) ABSTRACT

Illuminated optical sight reticle assemblies have a transparent element having opposed major surfaces and a periphery, a reticle image formed on one of the major surfaces of the transparent element, the reticle image defining a selected primary point, and an optical fiber having a first free end positioned proximate the selected primary point and an opposed second end away from the first end and proximate to an illumination source. There may be a fiber support structure having a periphery, and a span element extending from the periphery supporting the fiber. The fiber support structure may be a wire reticle. The fiber support structure periphery may have a first thickness, and the span may have a lesser second thickness. The fiber support structure periphery may be a ring. The span may include a first elongated element extending diametrically across the ring.

### FIELD OF THE INVENTION

The present invention relates to reticles, and more particularly to an illuminated reticle assembly that is bright enough for use in a daylight environment.

### BACKGROUND OF THE INVENTION

A reticle is a shape superimposed on an image that is used for precise alignment of a device, most notably that of a telescopic sight. The minimum reticle consists of simple crossed lines, or crosshairs, that meet at the optical center of the device. Most commonly associated with telescopic sights for aiming firearms, crosshairs are also common in optical instruments used for astronomy and surveying.

Telescopic sights for firearms, most commonly referred to as scopes, are the devices most often associated with crosshairs. While the traditional thin crossing lines are the original and most familiar crosshair shape, they are best suited for precision aiming at high contrast targets because the thin lines are easily lost in complex backgrounds, such as those encountered while hunting. Thicker bars are much easier to discern against a complex background, but lack the precision of thin lines. The most popular types of crosshairs in modern scopes are variants on duplex crosshairs, with bars that are thick on the perimeter and thin out in the middle. The thick bars allow the eye to quickly locate the center of the reticle, and the thin lines in the center allow for precision aiming and avoid obscuring a distant target.

There are two primary options for manufacturing the reticles for use in scopes: glass reticles and wire reticles. Glass reticles have features that are etched on the surface of a piece of glass and filled with blackened chrome. Glass reticles can have floating features, which means the etched portions do not have to be contiguous. An example of floating features is found in FIG. 2, which shows a glass reticle on the left side. The numbers next to the tics and the ranging scale in the upper left-hand quadrant are all floating features.

Wire reticles are typically made via an electroform process, which forms a thin layer of nickel in the shape of the reticle with all features built onto it. Wire reticles cannot have floating features; all features must be connected. Note that all the reticle features found in the wire reticle on the right side of FIG. 2 are contiguous.

It is desirable for the aiming point of riflescopes to be at the center of the circular field of view, because this provides a psychological confirmation of the aiming point, as well as providing a rough aiming point in rushed circumstances when discerning the cross hair aiming point is not possible. Moreover, while vertical holdovers tolerate some deviation from the center aiming point, lateral displacements of the aiming point would create a needless conflict with the user's natural expectation that the center of the circle will coincide with the center of aim.

Illuminated reticles at a minimum provide a red dot at the center of the circular field of view to facilitate identification of the aiming point, which is particularly useful in low light conditions. The ability to produce a red dot that is bright enough for use in a daylight environment is also desirable. Illuminated reticles are available for both glass and wire reticles. However, the ability to have a daylight bright reticle is most easily achieved with a wire reticle. Traditional illuminated glass reticles achieve illumination by bouncing the light off various surfaces that then reflect off a polished chrome portion of the reticle feature. This process wastes a lot of the light, and the result is a reticle that is illuminated, but not sufficiently to be used in a daylight environment.

A wire reticle is typically illuminated by affixing an optical fiber in a trough present on top of the electroformed reticle. The reason the optical fiber is installed in a trough is because when the electroformed reticle is installed in an electroformed reticle holder ring and subsequently installed into a scope, the top face of the electroformed reticle holder ring butts up against another surface in the scope. The trough provides sufficient space between the optical fiber and the top face of the electroformed reticle holder ring to avoid crushing the optical fiber between the electroformed reticle holder ring and the scope.

Therefore, a need exists for a new and improved illuminated optical sight reticle that enables a reticle with floating features to be illuminated with sufficient brightness for daytime use. In this regard, the various embodiments of the present invention substantially fulfill at least some of these needs. In this respect, the illuminated optical sight reticle according to the present invention substantially departs from the conventional concepts and designs of the prior art, and in doing so provides an apparatus primarily developed for the purpose of enabling a reticle with floating features to be illuminated with sufficient brightness for daytime use.

### SUMMARY OF THE INVENTION

The present invention provides an improved illuminated optical sight reticle, and overcomes the above-mentioned disadvantages and drawbacks of the prior art. As such, the general purpose of the present invention, which will be described subsequently in greater detail, is to provide an improved illuminated optical sight reticle that has all the advantages of the prior art mentioned above.

To attain this, the preferred embodiment of the present invention essentially comprises a transparent element having opposed major surfaces and a periphery, a reticle image formed on one of the major surfaces of the transparent element, the reticle image defining a selected primary point, and an optical fiber having a first free end positioned proximate the selected primary point, and an opposed second end away from the first end and proximate to an illumination source. There may be a fiber support structure having a periphery, and a span element extending from the periphery supporting the fiber. The fiber support structure may be a wire reticle. The fiber support structure periphery may have a first thickness, and the span may have a lesser second thickness. The fiber support structure periphery may be a ring. The span may include a first elongated element extending diametrically across the ring and a second elongated element intersecting the first elongated element. There are, of course, additional features of the invention that will be described hereinafter and which will form the subject matter of the claims attached.

There has thus been outlined, rather broadly, the more important features of the invention in order that the detailed description thereof that follows may be better understood and in order that the present contribution to the art may be better appreciated.

### BRIEF DESCRIPTION OF THE DRAWINGS

FIG. 1 is a side sectional view of the current embodiment of the illuminated optical sight reticle constructed in accordance with the principles of the present invention installed in a scope.

FIG. 2 is a rear isometric view of the illuminated optical sight reticle assembly of FIG. 1 removed from a scope and without holder rings.

FIG. 3 is an enlarged side sectional view of the rectangular area 3 of FIG. 1.

FIG. 4 is an enlarged side sectional view of the rectangular area 4 of FIG. 3.

FIG. 5 is an enlarged side sectional view of the rectangular area 5 of FIG. 3.

FIG. 6 is an enlarged front isometric partial view of the illuminated optical sight reticle assembly of FIG. 1.

FIG. 7 is an enlarged rear partial view of the illuminated optical sight reticle assembly of FIG. 1.

FIG. 8 is an enlarged rear partial view of the electroformed reticle portion of the illuminated optical sight reticle assembly of FIG. 1.

FIG. 9 is an enlarged rear isometric partial view of the wire reticle and optical fiber components of the illuminated optical sight reticle assembly of FIG. 1.

The same reference numerals refer to the same parts throughout the various figures.

### DESCRIPTION OF THE CURRENT EMBODIMENT

A current embodiment of the illuminated optical sight reticle assembly of the present invention is shown and generally designated by the reference numeral 10.

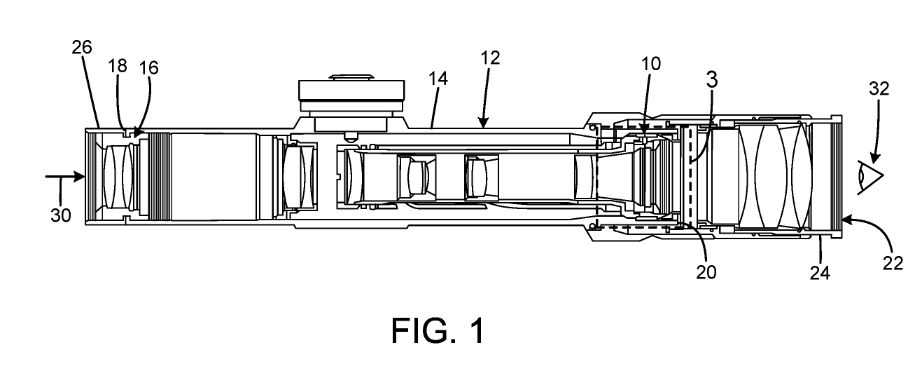

FIG. 1 illustrates the improved illuminated optical sight reticle assembly 10 of the present invention. More particularly, the reticle is shown installed in a scope 12 having a scope body 14. The scope body shown is an elongate tube tapering from a smaller opening 16 at the front 18 to a larger opening 20 at the rear 22. An eyepiece 24 is attached to the rear of the scope body, and an objective lens 26 is attached to the front of the scope body. The reticle is located near the front of the scope body behind the objective lens. Light 30 enters the front of the scope body and passes through the objective lens, reticle, and eyepiece before entering the eye of a viewer 32. As a result, the features present on the reticle are visible to the viewer and are superimposed over the image seen through the scope.

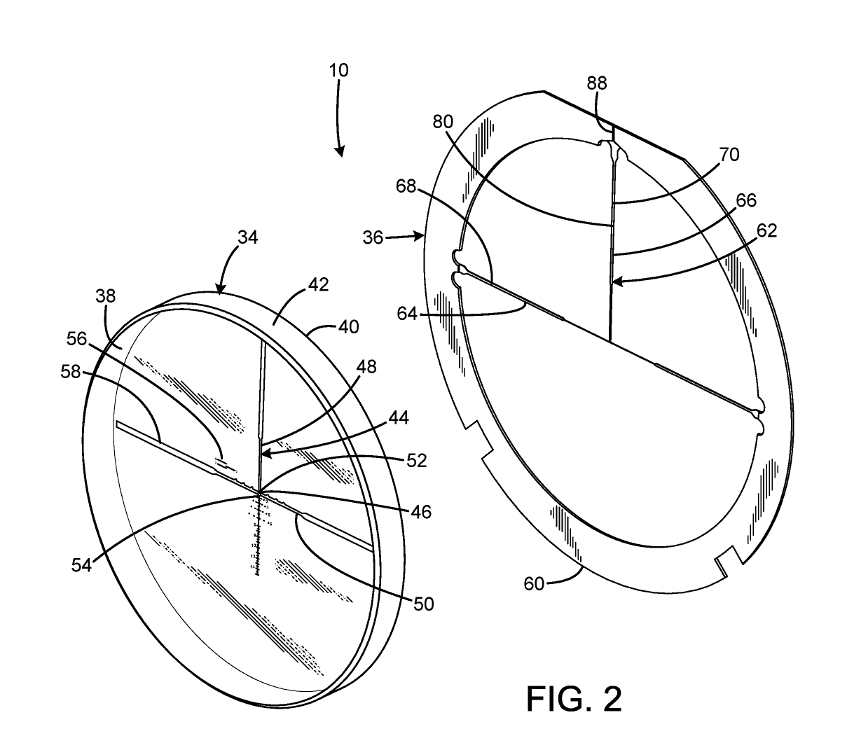

FIG. 2 illustrates the improved illuminated optical sight reticle assembly 10 of the present invention. More particularly, the reticle is shown removed from the scope 12. The reticle includes a glass reticle 34 and a wire reticle 36. In the current embodiment, the glass reticle is a disk of clear glass (a transparent element) with opposed rear and front planar surfaces 38, 40 (opposed major surfaces). A reticle image 44 is formed on one of the major surfaces of the transparent element. In the current embodiment, the reticle image is formed on the rear surface (a second surface) of the transparent element away from the viewer 32 by etching features on the rear surface and filling them with blackened chrome. The reticle image defines a selected primary point 46, which is at the center of a circular field of view in the current embodiment. The reticle image includes a vertical linear element 48 and a horizontal linear element 50 (a plurality of linear elements), each having free ends 52, 54 proximate to and spaced apart from each other to define the selected primary point (a viewing area). The reticle image includes an island portion 56 visibly separated from and disconnected from a periphery 58 of the reticle image.

The wire reticle 36 is a fiber support structure having a periphery 60 and a span element 62 extending from the periphery. In the current embodiment, the fiber support structure periphery has a first thickness, and the span element has a lesser second thickness. The fiber support structure periphery is a ring, and the span element includes a first elongated element 64 extending diametrically across the ring. The span element also includes a second elongated element 66 intersecting the first elongated element. In the current embodiment, the span element is a straight elongated bar. The first and second elongated elements have a selected width with an enlarged end portion 68, 70 at the fiber support structure periphery having a greater width. The fiber support structure has a first surface 80 facing the viewer 32.

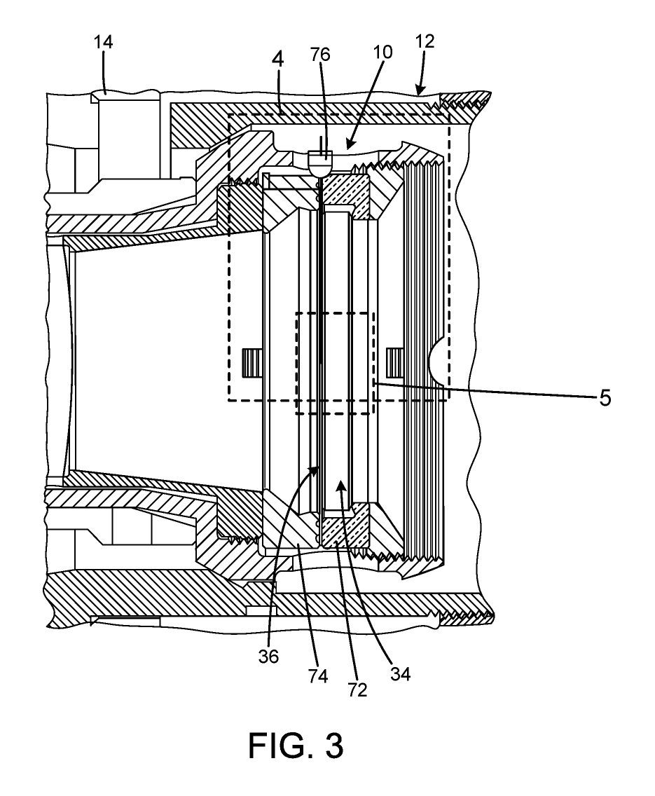

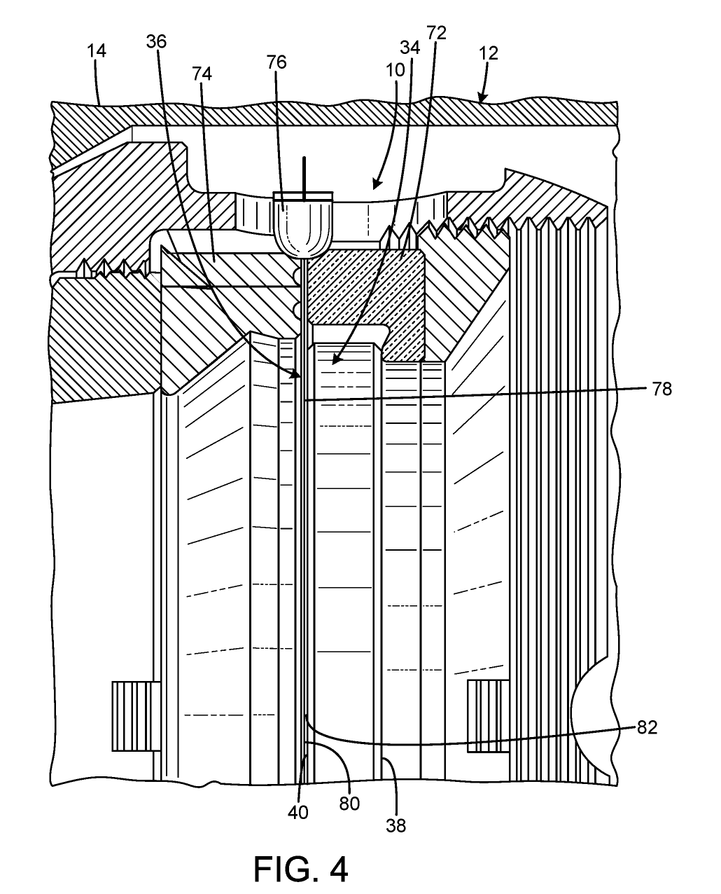

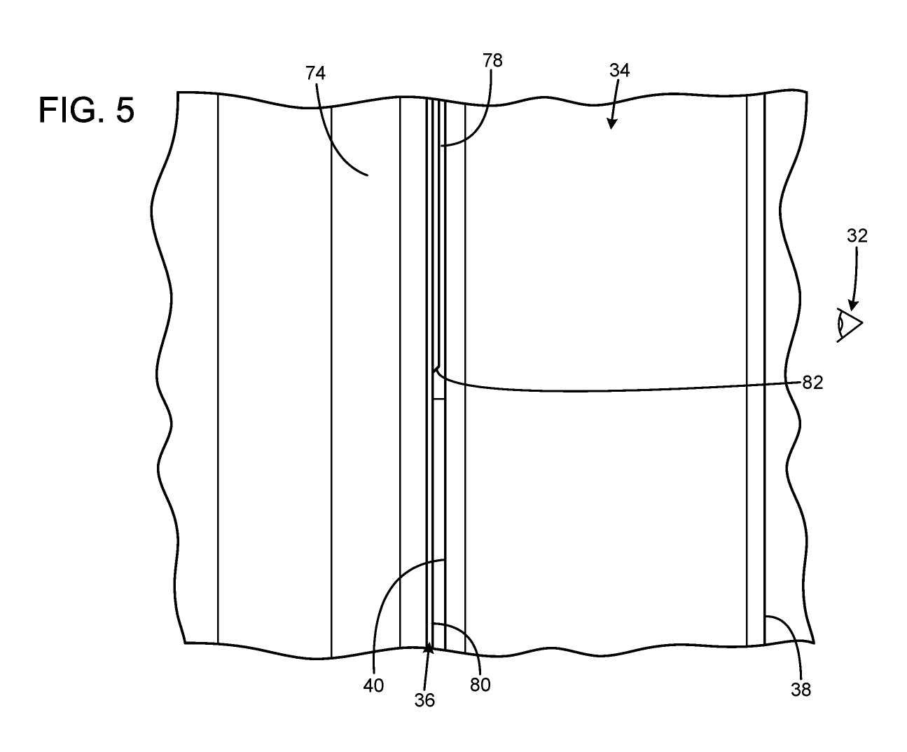

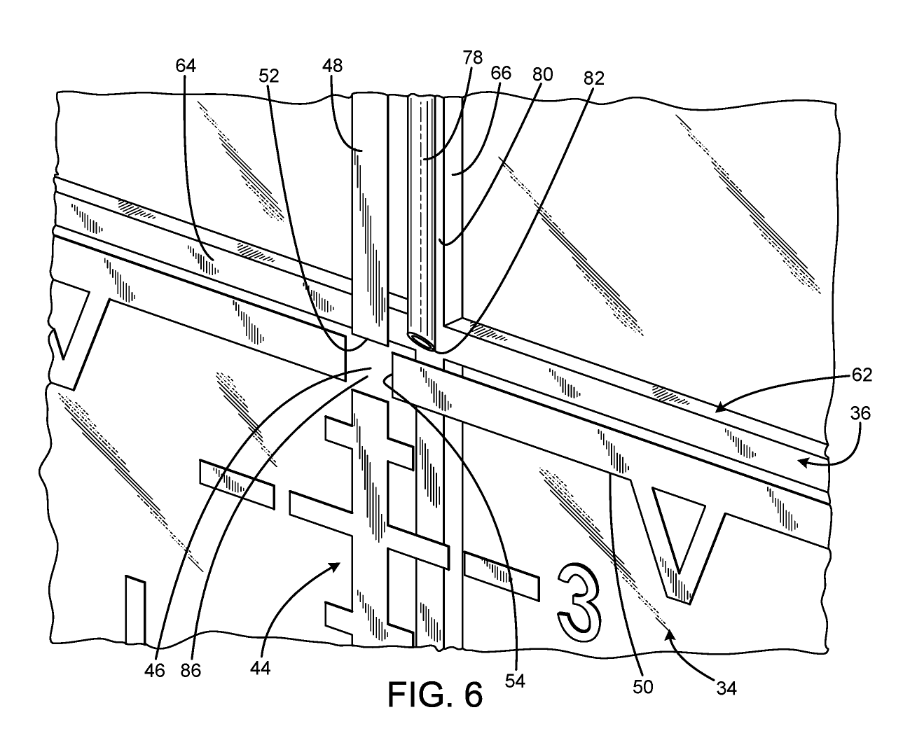

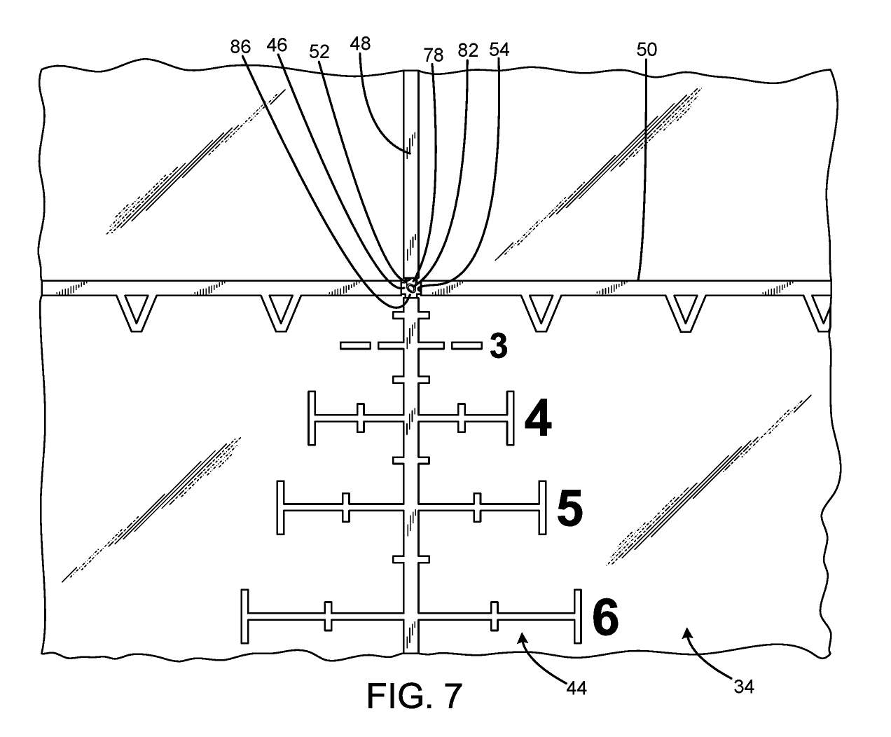

FIGS. 3-7 illustrate the improved illuminated optical sight reticle assembly 10 of the present invention. More particularly, the reticle is shown installed in the scope body 14 of scope 12. The glass reticle 34 is installed in a glass reticle holder ring 72, and the electroformed reticle 36 is installed in an electroformed reticle holder ring 74. An illumination source 76, in this case a light illuminating diode (LED), is positioned above the holder rings so that light emitted by the LED can pass between the holder rings. In the current embodiment, the LED emits red light. An optical fiber 78 is positioned facing the viewer 32 on the first surface 80 of the electroformed reticle on second elongated element 66 of span element 62 with the span element supporting the optical fiber. The optical fiber has a first free end 82 and an opposed second free end 84. The first free end is positioned proximate the selected primary point 46. The second free end is away from the first free end and proximate to the LED (an illumination source). In the current embodiment, the optical fiber is positioned between the span element and the glass reticle (the transparent element) and spaced apart from the glass reticle. The optical fiber is spaced apart from the glass reticle to avoid potentially crushing the optical fiber. Furthermore, if the optical fiber is directly attached to the glass reticle, light rays can potentially leave the optical fiber before reaching the first free end, thereby adversely affecting the brightness observed by the viewer 32. The optical fiber is proximate the rear surface 38 (the major surface) of the glass reticle on which the reticle image 44 is formed.

In the current embodiment, the span element 62 is coextensive with at least a portion of the reticle image 44 such that the span element is not visible to a user/viewer 32 of the illuminated optical sight reticle 10. The span element can be entirely concealed by the reticle image. The electroformed reticle 36 is located behind the glass reticle 34 relative to the viewer so any minor misalignments between the reticle image and the span element are concealed from the viewer. However, the positions of the wire reticle and the glass reticle could be reversed, with the reticle image printed on the front surface 40 of the glass reticle, and the glass reticle minimally spaced apart from the electroformed reticle. In this case, minor misalignments between the span element and the reticle image are also not detectable by the viewer. The reticle image can include a clear portion 86 at the primary point 46 such that first the free end 82 of the optical fiber 78 is visible through the clear portion when the electroformed reticle is located behind the glass reticle relative to the viewer. When the electroformed reticle is in front of the glass reticle relative to the viewer, the clear portion is not required. The clear portion can also be a viewing area defined by the free ends 52, 54 of the vertical and horizontal linear elements 48, 50 of the reticle image through which the first free end of the optical fiber is visible. Light rays emitted by the LED 76 that enter the second free end 84 of the optical fiber at an angle above the critical angle based on the index of refraction of the material composing the optical fiber achieve total internal reflection. This enables light rays traveling through the optical fiber to exit the optical fiber at the first free end with minimal loss. This minimal loss of light is what enables the exiting light rays to appear daylight bright to a viewer 32 looking through the eyepiece 24 of the scope 12. The first free end of the optical fiber is cut/polished at a 45° angle so the illumination appears as a circle/red dot to the viewer. The clear portion between the free ends of the vertical and horizontal linear elements of the reticle image is necessary so the first free end of the optical fiber is not blocked by blackened chrome. Thus, the clear portion makes reticle features from the glass reticle and reticle features from the electroformed reticle simultaneously visible to the viewer. The size of the clear portion can be enlarged or reduced during manufacturing of the glass reticle to expose more or less of the reticle features from the electroformed reticle to the viewer.

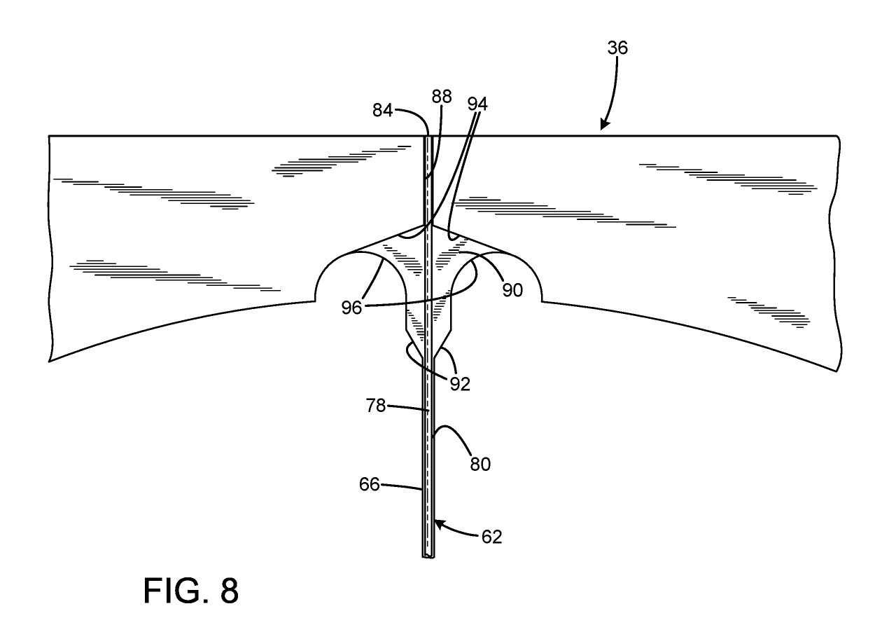

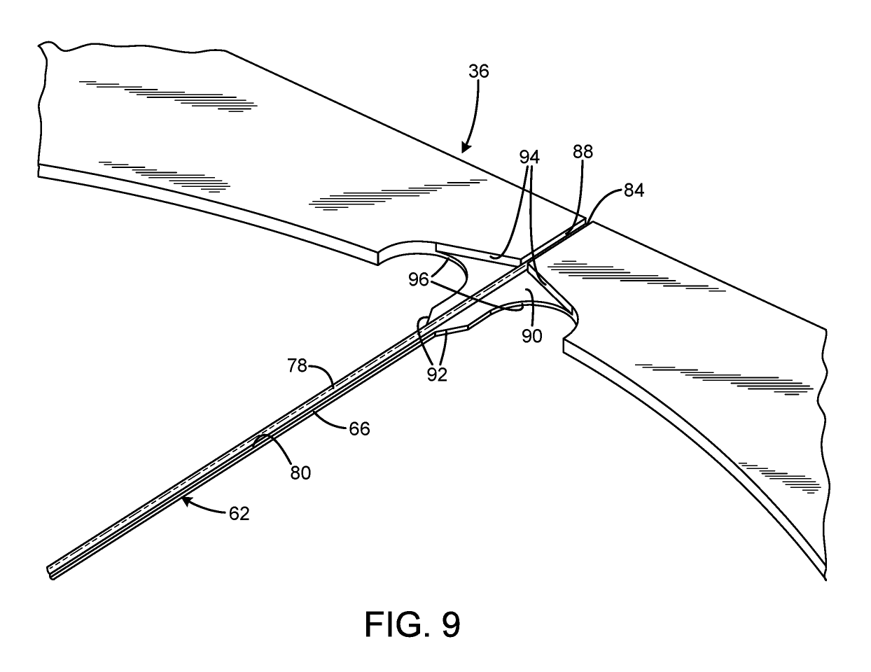

FIGS. 8 and 9 illustrate the illuminated optical sight 10 of the present invention. More particularly, the optical fiber 78 is shown affixed to the first surface 80 of second elongated element 66 of span element 62 of the wire reticle 36. A trough 88 is axially registered with the second elongated element. The optical fiber runs through the trough and runs the length of the second elongated element so the first free end 82 of the optical fiber is located at the optical center of the electroformed reticle. The optical fiber is attached to the second elongated element by first applying an adhesive to the second elongated element. Subsequently, a technician simultaneously rotates the optical fiber to achieve maximum brightness, places the optical fiber on the second elongated element without any overhang of the fiber or adhesive that would obscure the second elongated element's geometry, and place the optical fiber so the first free end is located at the optical center of the electroformed reticle. Finally, the adhesive is cured using any suitable method.

The optical fiber 78 installation process on a conventional wire reticle creates several challenges for the technician. Because the adhesive is applied first, and then the optical fiber is set on top of the adhesive, the adhesive can squeeze out to the sides from under the optical fiber, potentially changing the apparent geometry of the second elongated element 66. In addition, the adhesive can manifest a wicking action that results in the adhesive traveling up though the trough 88. If a significant amount of hand manipulation of the optical fiber by the technician is required to achieve maximum brightness and correct location, the adhesive can exit the trough and block the second free end 84. When the second free end is blocked by adhesive, a significant portion of the light rays emitted by LED 76 cannot enter the optical fiber, and the electroformed reticle will not be satisfactorily illuminated at the first free end 82, especially in bright daylight. To prevent the second free end from being blocked by wicking adhesive, some length of optical fiber is left protruding from the electroform reticle during installation. However, the protruding length is unsupported, leaving it susceptible to warping, damage, or other undesirable factors that adversely affect the brightness at the first free end. Furthermore, the variably protruding length prevents a tighter positional tolerance for the second free end of the optical fiber, which is important when the scope 12 is assembled, because the position of the LED relative to the second free end is directly related to the intensity of the light at the first free end.

The wire reticle 36 of the present invention addresses the problems caused by adhesive wicking into the trough 88 by narrowing and tightly controlling the width of the trough and by providing a glue trap 90 below the trough. A narrower trough, which is 0.068+/−0.02 mm in the current embodiment, provides a physical barrier to prevent the adhesive from wicking up the length of the optical fiber. The narrower trough also assists the technician in more precisely locating the optical fiber on the second elongated element 66. The glue trap is a recessed platform area that enables wicking adhesive to pool there below the trough instead of entering the trough. In the current embodiment, the fiber support structure periphery 60 has a thickness of 0.140+/−0.025 mm, and the glue trap has a thickness of 0.060+/−0.025 mm. The glue trap has tapered portions 92 at an angle of 60° that transition the second elongated element from a width of 0.1+/−0.005 mm at the enlarged end portion 70 to a width of 0.34 mm. The glue trap has rear angled portions 94 at an angle of 140° that are tangential to semi-circular portions 96 having a radius of 0.4 mm. The second elongated element has a total length of 9.5 mm below the tapered portion and a total length of 11.43 mm including the glue trap and the thickness of the fiber support structure periphery.

In the context of the specification, the terms “rear” and “rearward,” and “front” and “forward” have the following definitions: “rear” or “rearward” means in the direction away from the muzzle of the firearm while “front” or “forward” means it is in the direction towards the muzzle of the firearm.

While a current embodiment of an illuminated optical sight reticle assembly has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An illuminated optical sight reticle assembly comprising:
a transparent element having opposed major surfaces;
a reticle image formed on one of the major surfaces of the transparent element;
the reticle image defining a selected primary point; and
an optical fiber having a first free end positioned proximate the selected primary point,
and an opposed second free end away from the first free end and proximate to an illumination source.

2. The illuminated optical sight reticle assembly of claim 1 including a fiber support structure having a periphery, and a span element extending from the periphery, the span element supporting the optical fiber.

3. The illuminated optical sight reticle assembly of claim 2 wherein the fiber support structure is a wire reticle.

4. The illuminated optical sight reticle assembly of claim 2 wherein the fiber support structure periphery has a first thickness, and the span element has a lesser second thickness.

5. The illuminated optical sight reticle assembly of claim 2 wherein the fiber support structure periphery is a ring, and wherein the span element includes a first elongated element extending diametrically across the ring.

6. The illuminated optical sight reticle assembly of claim 5 wherein the span element includes a second elongated element intersecting the first elongated element.

7. The illuminated optical sight reticle assembly of claim 2 wherein the span element is coextensive with at least a portion of the reticle image such that the span element is not visible to a user of the illuminated optical sight reticle.

8. The illuminated optical sight reticle assembly of claim 7 wherein the span element is entirely concealed by the reticle image.

9. The illuminated optical sight reticle assembly of claim 2 wherein the optical fiber is positioned between the span element and the transparent element.

10. The illuminated optical sight reticle assembly of claim 9 wherein the optical fiber is spaced apart from the transparent element.

11. The illuminated optical sight reticle assembly of claim 2 wherein the span element is a straight elongated bar.

12. The illuminated optical sight reticle assembly of claim 1 wherein the optical fiber is proximate the major surface on which the reticle image is formed.

13. The illuminated optical sight reticle assembly of claim 1 wherein the reticle image is formed on a second surface of the transparent element away from a viewer and wherein the fiber is positioned on a first surface of the fiber support structure facing the viewer.

14. The illuminated optical sight reticle assembly of claim 1 wherein the reticle image includes an island portion visually separated from and disconnected from a periphery of the reticle image.

15. The illuminated optical sight reticle assembly of claim 1 wherein the reticle image includes a clear portion at the primary point such that the first free end of the optical fiber is visible through the clear portion.

16. The illuminated optical sight reticle assembly of claim 1 wherein the reticle image includes a plurality of linear elements extending inward, each having free ends proximate to and spaced apart from each other to define a viewing area through which the first free end of the optical fiber is visible.

17. The illuminated optical sight reticle assembly of claim 2 wherein the span element includes an elongated portion having a selected width, and having an enlarged end portion at the periphery having a greater width.
